(19) United States
(12) Patent Application Publication
(10) Pub. No.: US 2019/0288343 A1
(43) Pub. Date: Sep. 19, 2019

(54) METHODS AND APPARATUS FOR A BATTERY

(71) Applicant: Landmark Battery Innovations, Inc., Austin, TX (US)

(72) Inventors: Viet Vu, Leander, TX (US); Ajoy Datta, Fullerton, CA (US); Lucien Fontaine, Cedar Park, TX (US); Andrew Parth, Austin, TX (US)

(21) Appl. No.: 15/920,700

(22) Filed: Mar. 14, 2018

(51) Int. Cl. H01M 10/28; H01M 10/30; H01M 4/70; H01M 4/32; H01M 4/52; H01M 4/24

(52) U.S. Cl. CPC H01M 10/28; H01M 10/30; H01M 4/70; H01M 2004/029; H01M 4/521; H01M 4/52; H01M 4/24; H01M 4/32

(57) ABSTRACT

Various embodiments of the present technology comprise a method and apparatus for a battery. According to various embodiments, the battery comprises a layered structure comprising a current collector, an active material, and a non-electrically conductive permeable layer. The layered structure is repeated with a separator disposed between adjacent layered structures.

### BACKGROUND OF THE TECHNOLOGY

To improve the stability and reliability of solar and wind energy sources, energy storage systems, such as a battery, are needed to store the excess energy and balance the energy supply and demand. Nickel-iron storage batteries have attracted attention because of their ability to tolerate numerous overcharge and over-discharge states when weather conditions are unpredictable.

In general, during charge, and particularly overcharge, the nickel-iron battery generates more gas than other alkaline storage batteries because the electrochemical potential for the reduction of water on an anode is very close to the reduction potential of iron oxides to iron metal. Accordingly, the battery will produce hydrogen gas at the same time iron is deposited from iron oxide, as shown in the following equations:

2H₂O+2e→H₂+2OH E=−0.828V

Fe(OH)₂+2e→Fe+2OH E=−0.877V

A cathode of the battery comprises nickel hydroxide, which also generates oxygen gas near the end of a charge cycle and during over-charge according to the following equations:

2OH→1/2O₂+H₂O+2e E=0.401V

2Ni(OH)₂+2OH→2NiOOH+2H₂O+2e E=0.49V

Gas generation reduces the efficiency of the battery, increases the need for topping up the battery with electrolyte, and is a significant cause for the disintegration of electrode materials and loss of electrical contact with a current collector. Accordingly, a construction that prevents loss of the active materials during cycling may exhibit longer cycle life. A construction that has a higher energy density, lower manufacturing costs, and lower internal resistance is also desirable.

### SUMMARY OF THE INVENTION

Various embodiments of the present technology comprise a method and apparatus for a battery. According to various embodiments, the battery comprises a layered structure comprising a current collector, an active material, and a non-electrically conductive permeable layer. The layered structure is repeated with a separator disposed between adjacent layered structures.

### BRIEF DESCRIPTION OF THE DRAWING FIGURES

A more complete understanding of the present technology may be derived by referring to the detailed description when considered in connection with the following illustrative figures. In the following figures, like reference numbers refer to similar elements and steps throughout the figures.

FIG. 1 is a cross-sectional view of a battery in accordance with various embodiments of the present technology;

FIG. 2 is an exploded view of the battery in accordance with a first embodiment of the present technology;

FIG. 3 is a cross-sectional view along a wall of a battery in accordance with a second embodiment of the present technology;

FIG. 4 is an exploded view of the battery in accordance with the second embodiment of the present technology;

FIG. 5 is a cross-sectional view along a wall of a battery in accordance with a third embodiment of the present technology;

FIG. 6 is an exploded view of the battery in accordance with the third embodiment of the present technology;

FIG. 7 is a mono-polar battery in accordance with an exemplary embodiment of the present technology;

FIG. 8 is an exploded view of the mono-polar battery in accordance with an exemplary embodiment of the present technology;

FIG. 9 is an exploded view of a bipolar plate in accordance with an exemplary embodiment of the present technology;

FIG. 10 is an exploded view of a half-plate in accordance with an exemplary embodiment of the present technology;

FIG. 11 is a current collector in accordance with the first embodiment of the present technology;

FIG. 12 is a cross-sectional view of the current collector in accordance with the first embodiment of the present technology;

FIG. 13 is a current collector in accordance with the second embodiment of the present technology;

FIG. 14 is a cross-sectional view of the current collector in accordance with the second embodiment of the present technology;

FIG. 15 is a cross-sectional view of the bipolar plate in accordance with one embodiment of the present technology;

FIG. 16 is a cross-sectional view of the bipolar plate in accordance with an alternative embodiment of the present technology;

FIG. 17 is a graph illustrating the area specific resistance of a conventional bipolar cell versus a bipolar cell in accordance with an exemplary embodiment of the present technology;

FIG. 18 is a graph illustrating the energy of a conventional bipolar cell versus a bipolar cell in accordance with an exemplary embodiment of the present technology; and

FIG. 19 is a graph illustrating the gravimetric area specific resistance of a conventional bipolar cell versus a bipolar cell in accordance with an exemplary embodiment of the present technology.

### DETAILED DESCRIPTION OF EXEMPLARY EMBODIMENTS

The present technology may be described in terms of functional block components and various processing steps. Such functional blocks may be realized by any number of components configured to perform the specified functions and achieve the various results. For example, the present technology may employ various electrolytes, active materials, battery containers, and the like, which may carry out a variety of functions. In addition, the present technology may be practiced in conjunction with any number of alkaline storage battery systems, and the systems described are merely exemplary applications for the technology.

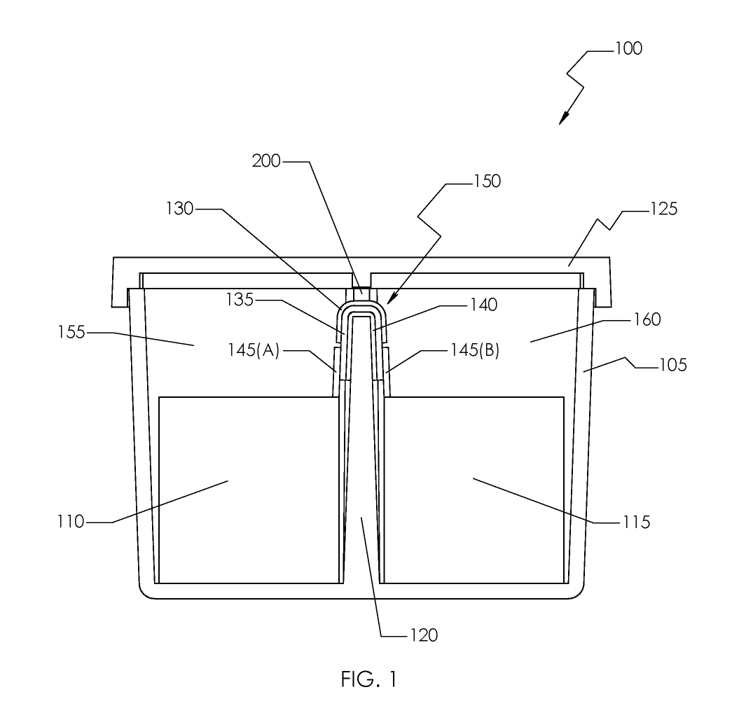

Methods and apparatus for a battery 100 according to various aspects of the present technology may operate in conjunction with any suitable energy system and/or device, such as solar power system, wind power system, and the like. Referring to FIG. 1, the battery 100 stores energy that may be used as an energy source to operate other devices and/or systems. The battery 100 may be electrically coupled to an energy system and receive and store energy from the energy system and/or generate and transmit energy to the energy system. The battery 100 may be configured as a rechargeable, nickel-iron battery.

Referring to FIG. 1, the battery 100 may comprise a battery container 105 to hold a first battery cell 110 and a second battery cell 115. The battery container 105 may comprise a wall 120 to partition the battery container 105 into at least two compartments, such as a first compartment 155 and a second compartment 160, where the first compartment 155 houses the first battery cell 110 and the second compartment 160 houses the second battery cell 115. Each compartment 155, 160 may further comprise an electrolyte solution (not shown) to serve as a catalyst to make the battery 100 conductive by promoting the movement of ions from the cathode to the anode, and vise versa. According to various embodiments, the battery container 105 may be formed using any suitable material, such as polypropylene or acrylonitrile butadiene styrene (ABS).

Each battery cell 110, 115 may comprise a cell connection tab 145(A), 145(B) to facilitate a connection between the battery cells 110, 115. The cell connection tabs 145(A), 145(B) may be coupled together via an intercell connection 150.

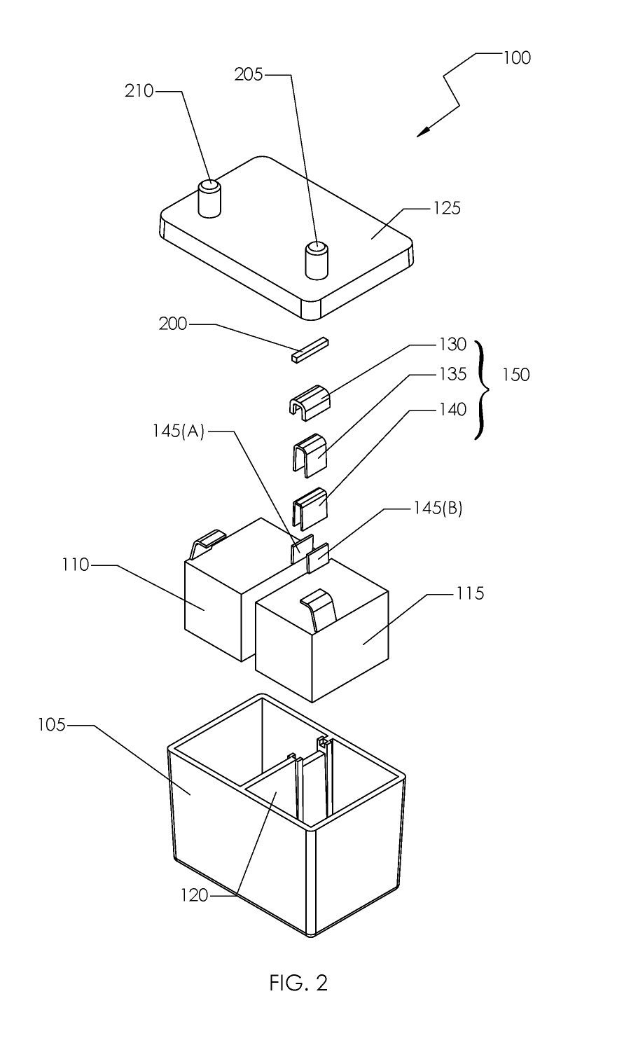

The battery 100 may further comprise a lid 125 adapted to secure to a top, open portion of the battery container 105. In various embodiments, the lid 125 may comprise a protrusion (not shown) on an inner surface that makes contact with the wall 120 and/or the intercell connection 150 to provide a liquid tight seal. Referring now to FIG. 2, the lid 125 may further comprise two external terminals, such as a positive terminal 205 and a negative terminal 210 that are used to connect the battery 100 to the power source and/or power system. The lid 125 may further comprise apertures (not shown) for filling each compartment 155, 160 with the electrolyte solution.

The intercell connection 150 provides an electrically conductive path from the first battery cell 110 to the second battery cell 115. The intercell connection 150 may also provide low internal electrical resistance, is free of mechanical components, and allows each compartment to remain sealed. For example, the intercell connection 150 may comprise an inner seal 140 and an outer seal 130 to prevent electrolyte migration between the battery cells 110, 115 and/or out of the battery container 105. In various embodiments, each seal 140, 130 extends from the first compartment 155, up and over the wall 120, and into the second compartment 160. In other words, the inner and outer seals 140, 130 may generally form a U-shape to conform to the wall 120. Each of the inner and outer seals 140, 130 may comprise any suitable electrically insulating material and/or one that is chemically resistant to the electrolyte solution, such as butyl rubber.

The intercell connection 150 may further comprise an intercell connection tab 135 disposed between the inner seal 140 and the outer seal 130 to further facilitate the electrical connection between the first and second battery cells 110, 115. For example, the intercell connection 150 may comprise a single element that extends from the first compartment 155 into the second compartment 160. The intercell connection 150 may form a same or similar shape as the inner and outer seals 140, 130, such as a U-shape, and may have a rectangular cross-section. The intercell connection tab 135 may abut the cell connection tabs 145(A), 145(B) to couple the cell connection tabs 145(A), 145(B) together. For example, the intercell connection tab 135 may comprise any material suitable for providing electrical conduction, such as nickel-plated steel. The intercell connection tab 135 may comprise any size suitable for carrying a desired current.

The intercell connection 150 may further comprise an adhesive 200 disposed between the outer seal 130 and the lid 125 and used to secure the lid 125 to the wall 120. The adhesive 200 may comprise any material that can withstand heating and/or having mechanical and chemical resistance properties. For example, the adhesive may comprise a hot melt adhesive such as LOCTITE® HYSOL 6009S.

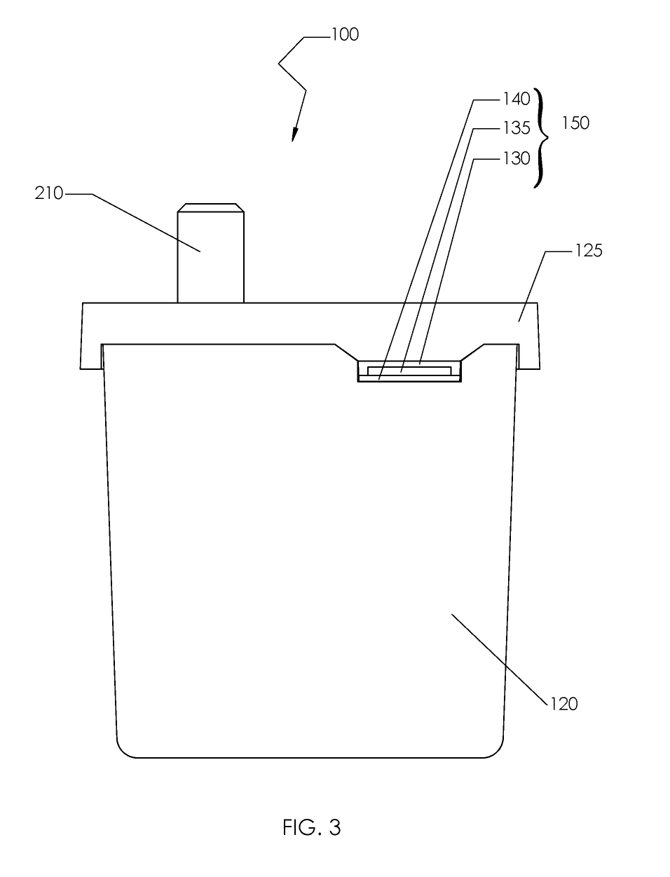

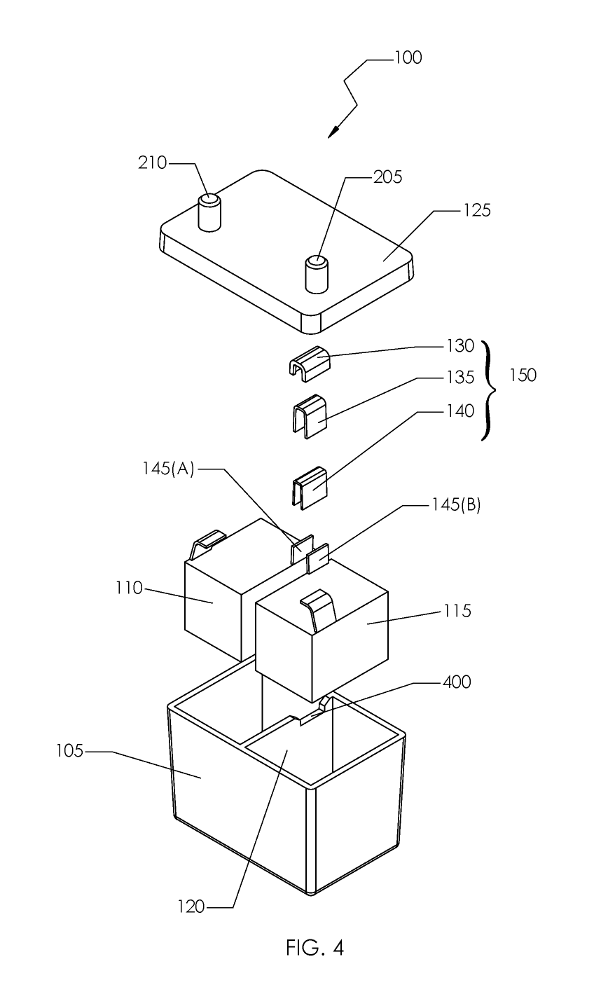

Referring to FIGS. 2-4, in various embodiments, the intercell connection 150 may be recessed in the wall 120. For example, the wall 120 may comprise a notch 400 for receiving the intercell connection 150. The notch 400 may comprise vertical side walls or angled side walls. In various embodiment, and referring to FIG. 3, the lid 125 may comprise a protrusion that mirrors the shape of the notch 400.

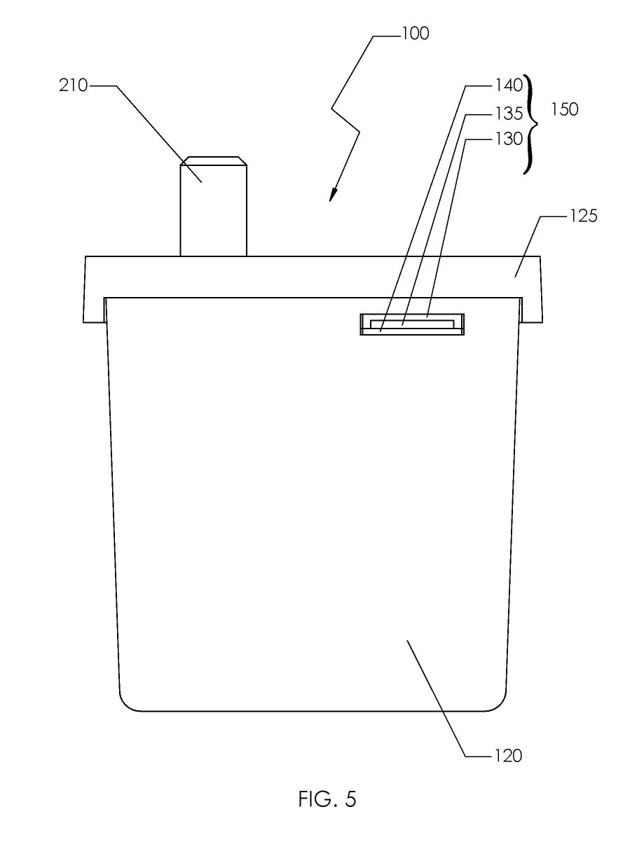

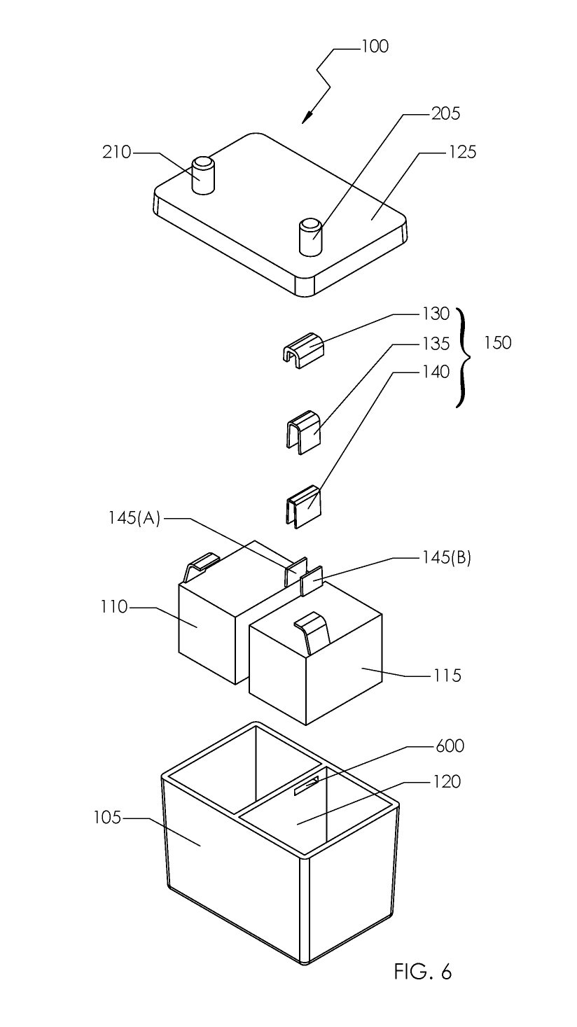

Referring to FIGS. 5 and 6, in an alternative embodiment, the wall 120 may comprise an opening 600 to allow the intercell connection 150 to pass through. In this present embodiment, the intercell connection 150 fills the opening 600 such that the intercell connection 150 forms a seal between the wall 120 and the inner and outer seals 140, 130.

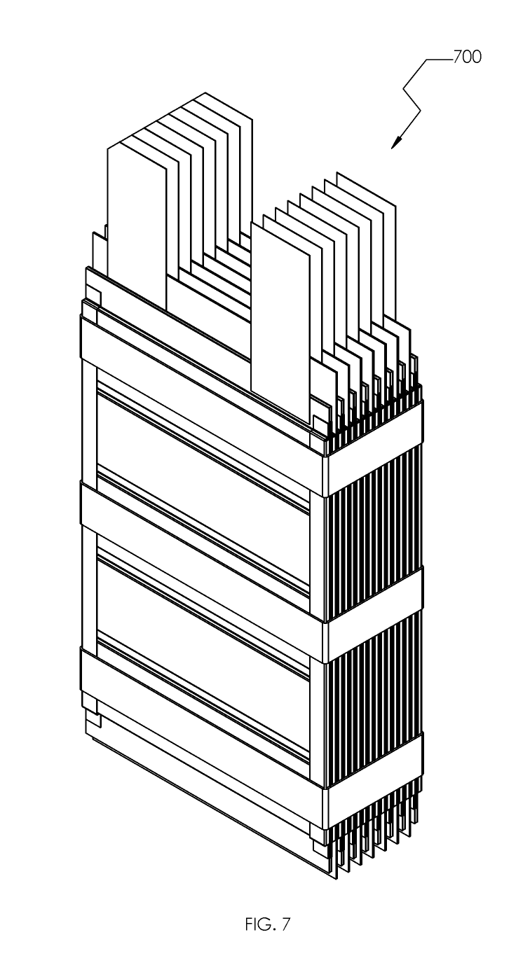

Referring to FIGS. 1, 7, 8, and 9, the battery 100 may comprise a mono-polar battery 700. For example, the first compartment 155 may comprise the mono-polar battery 700 submerged in an alkaline electrolyte that contains, for example potassium, sodium, and/or lithium ions. The second compartment 160 may be configured similarly as the first compartment 155. In an exemplary embodiment, the mono-polar battery 700 may comprise a stacked structure of repeating elements secured together with one or more bands 810(A), 810(B), 810(C). For example, the mono-polar battery 700 may comprise a plurality of bipolar plates 800, wherein adjacent bipolar plates 800 are separated by a bipolar separator 805. In other words, a first bipolar separator 805(A) is disposed between the a first bipolar plate 800(A) and a second bipolar plate 800(B) and a second bipolar separator 805(B) is disposed between the second bipolar plate 800(B) and a third bipolar plate 800(C).

The mono-polar plate 700 may comprise any number of bipolar plates 800 and bipolar separators 805. According to an exemplary embodiment, the number of bipolar plates 800 is one greater than the number of bipolar separators 805.

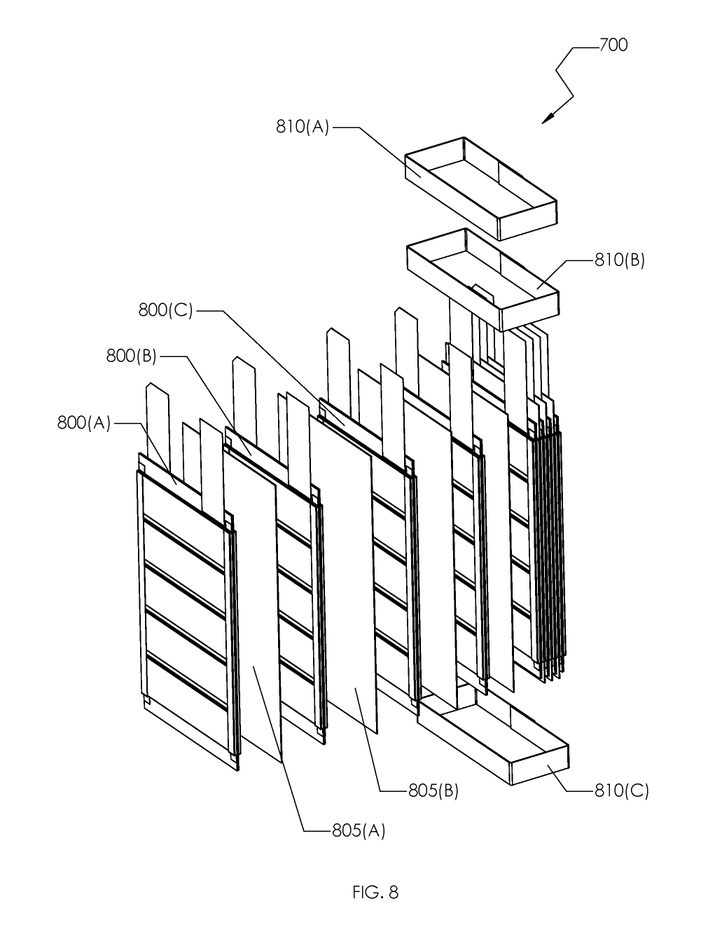

Each bipolar plate 800 is an ionic conductor that facilitates the passage of ions and lowers the ionic resistance of the battery 100. Further, the bipolar plates 800 do not conduct electricity, and therefore are resistant to corrosion. Referring to FIG. 9, each bipolar plate 800 may comprise a positive half-plate 900(A) and a negative half-plate 900(B) with a half-plate separator 910 disposed between them. The half-plate separator 910 may comprise a sheet of non-woven spun-bonded nylon material, however alternative materials, such as polypropylene, polyethylene, and other chemically-compatible materials may be used.

Each bipolar plate 800 may further comprise a sealant to seal the positive half-plate 900(A), the half-plate separator 910, and the negative half-plate 900(B) together. For example, the bipolar plate 800 may comprise a first gasket 1035(A) disposed between the positive half-plate 900(A) and the negative half-plate 900(B) at a first end 920 and a second gasket 1035(B) at an opposing second end 925. The gasket 1035 may comprise an elastomer rubber, or any other material or compound suitable for use as a sealant and/or adhesive.

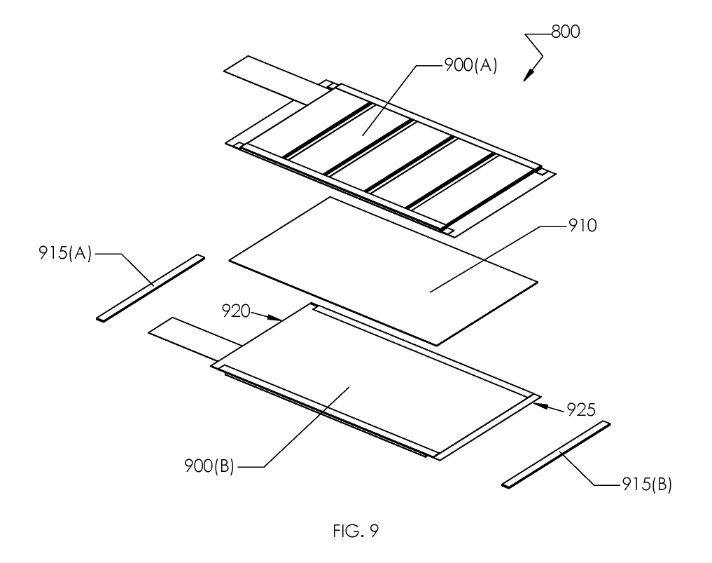

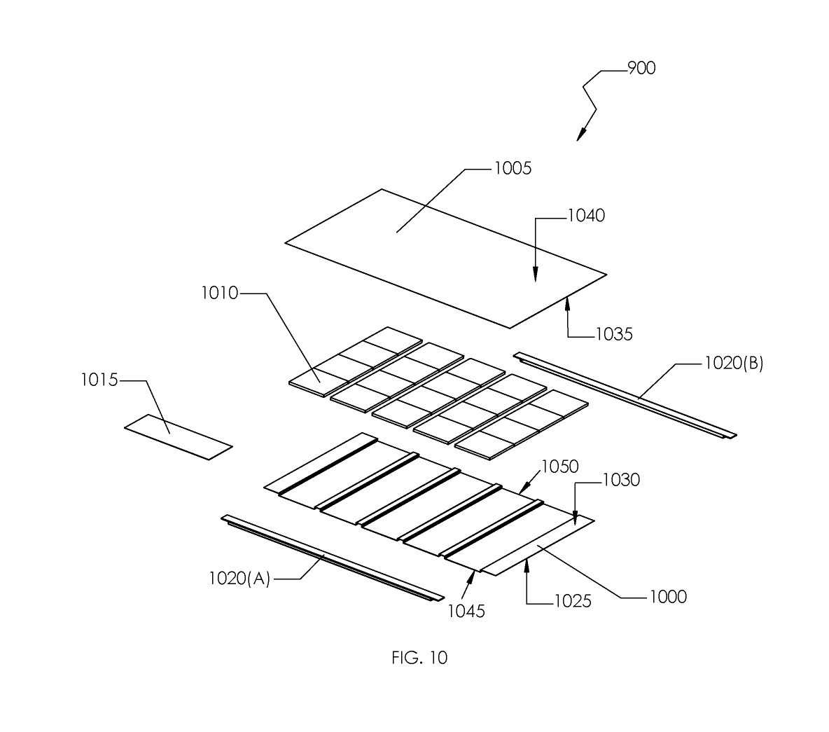

Referring to FIG. 10, each half-plate 900 comprises a plurality of pellets 1010 disposed between a current collector 1000 and a permeable layer 1005.

The plurality of pellets 1010 may comprise an active material and may have a negative charge (a first polarity) or positive charge (a second polarity). For example, the pellets 1010 may comprise a form of nickel hydrate or other suitable material, which results in a positive charge (positive charge pellets), or the pellets 1010 may comprise iron oxide or other suitable material, which results in a negative charge (negative charge pellets). A half-plate 900 comprising positive charge pellets may be referred to as a positive half-plate, and a half-plate 900 comprising negative charge pellets may be referred to as a negative half-plate.

The current collector 1000 aids in housing the pellets 1010 and is constructed of a thin sheet of an electrically conducting material, such as steel, nickel, nickel-plated steel, and the like, and comprises a first major surface 1025 and an opposing second major surface 1030 According to various embodiments, the pellets 1010 are arranged adjacent to the second major surface 1030 of the current collector 1000.

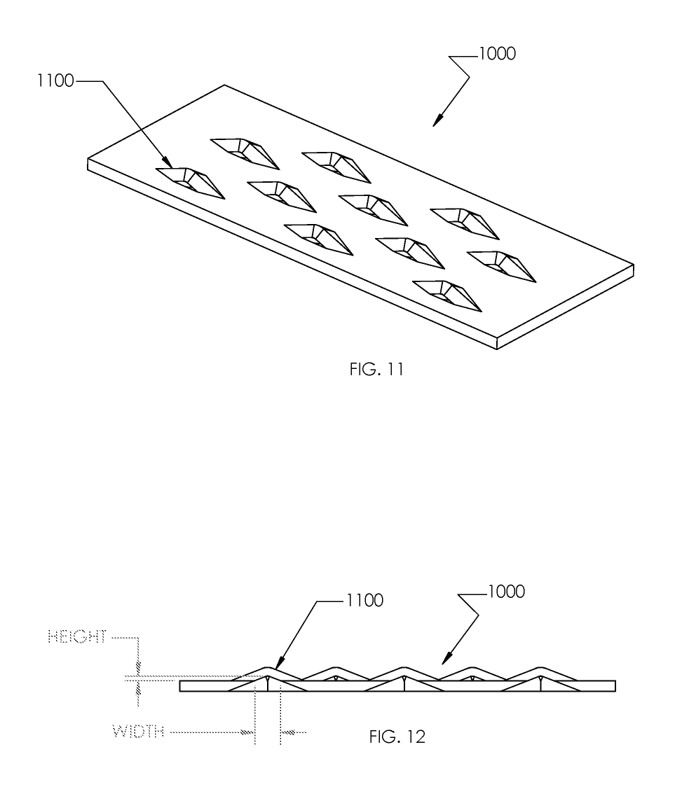

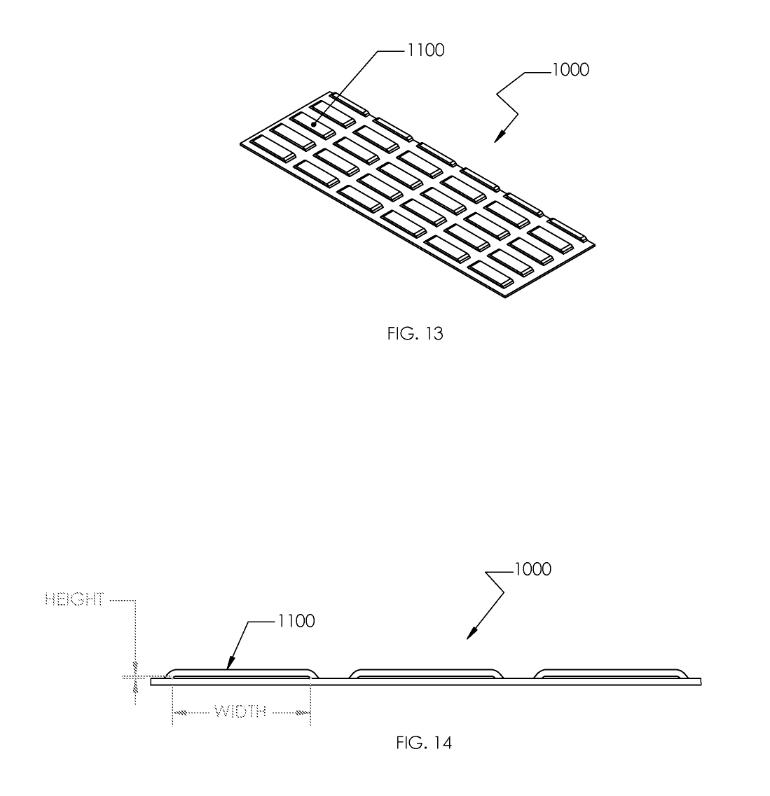

Referring to FIGS. 11-14, various embodiments of the current collector 1000 comprise a plurality of protuberances 1100 disposed along at least one major surface of the current collector 1000. The protuberances 1100 may form a repeating pattern across the second major surface 1030 of the current collector 1000 and may be formed by a combination of lancing (or perforating) and stamping. In one embodiment, and referring to FIGS. 11 and 12, each protuberance 1100 comprises one opening. In an alternative embodiment, and referring to FIGS. 13 and 14, each protuberance 1100 comprises two openings, one on each side. Each protuberance 110 may comprise any shape and size suitable to withstand compression during assembly of the bipolar plate 900. In exemplary embodiments, the opening of each protuberance has a height ranging from 20 to 200 microns and has a width ranging from 0.10 to 4.00 millimeters.

The permeable layer 1005 may comprise a non-electrically conductive material. For example, the permeable layer 1005 may comprise a solid film of hydrophilic polymer or a perforated film of hydrophilic and hydrophobic polymers. According to an exemplary embodiment, the permeable layer 1005 has an ionic permeability that allows the battery electrolyte to flow freely through it. The permeable layer 1005 may be vertically aligned and in parallel with the current collector 1000. In other words, the permeable layer 1005 comprises a first major surface 1035 and a second major surface 1040, wherein the first major surface 1035 of the permeable layer 1005 is facing the second major surface 1030 of the current collector 1000.

Each bipolar plate 900 may further comprise a tab 1015 disposed between a portion of the current collector 1000 and the permeable layer 1005 and extending outwardly from the first or second end. Multiple tabs 1015 may be connected by a conductive bus (not shown). The tab 1015 may comprise any suitable metal, such as nickel-plated steel, stainless steel, nickel, and the like. The tab 1015 may be any suitable shape and size, and in an exemplary embodiment, the tab 1015 is generally of a rectangular shape.

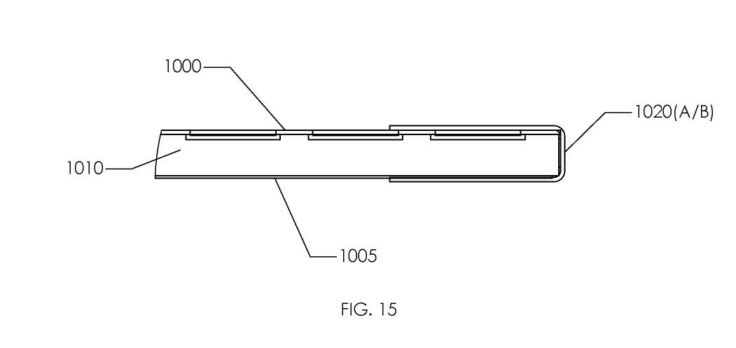

In various embodiments, the half-plate 900 may be joined together along two opposing edges. For example, and referring to FIGS. 10 and 15, the half-plate may further comprise a first side rail 1020(A) along a first edge 1045 and a second side rail 1020(B) along an opposing second edge 1050. The side rail 1020 may be constructed of a metal, similar to or the same as that used to construct the current collector 1000. The side rail 1020 may be substantially U-shaped or any other suitable shape that can extend over both a top surface and a bottom surface of the half-plate 900 to allow the current collector 1000, the pellets 1010, and the permeable layer 1005 to be clamped, or otherwise crimped, together.

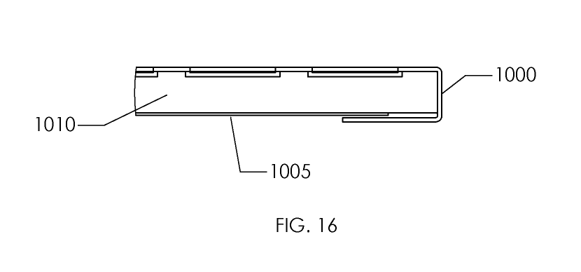

In an alternative embodiment, and referring to FIG. 16, the current collector 1000 may comprise an edge that extends up and around an edge of the permeable layer 1005. In other words, the edge of the current collector 1000 may be folded onto an edge of the permeable layer 1005 during assembly. In an exemplary embodiment, two opposing edges, such as the first and second edges 1045, 1050, of the current collector 1000 may be folded to secure the permeable layer 1005 and pellets 1010 to the current collector 1000.

Accordingly, the mono-polar battery 700 may be described as a plurality of layered stacks (i.e., bipolar plates 800), wherein each layered stack comprises, and is in the order of: the negative half-plate 900(B), the half-plate separator 910, the positive half-plate 900(A). Each layered stack is further separated with the bipolar separator 805. Further, each half-plate 900 comprises a layered stack, and is in the order of: the current collector 1000, the plurality of pellets 1010, and the permeable layer 1005. The negative half-plate 900(B), the half-plate separator 910, and the positive half-plate 900(A) are arranged such that the bipolar separator 805 abuts the permeable layers 1005 from each of the half-plates. In other words, the permeable layers 1005 are in an interior position in the bipolar plate stack and the current collectors 1000 are the first and final layers of the stack.

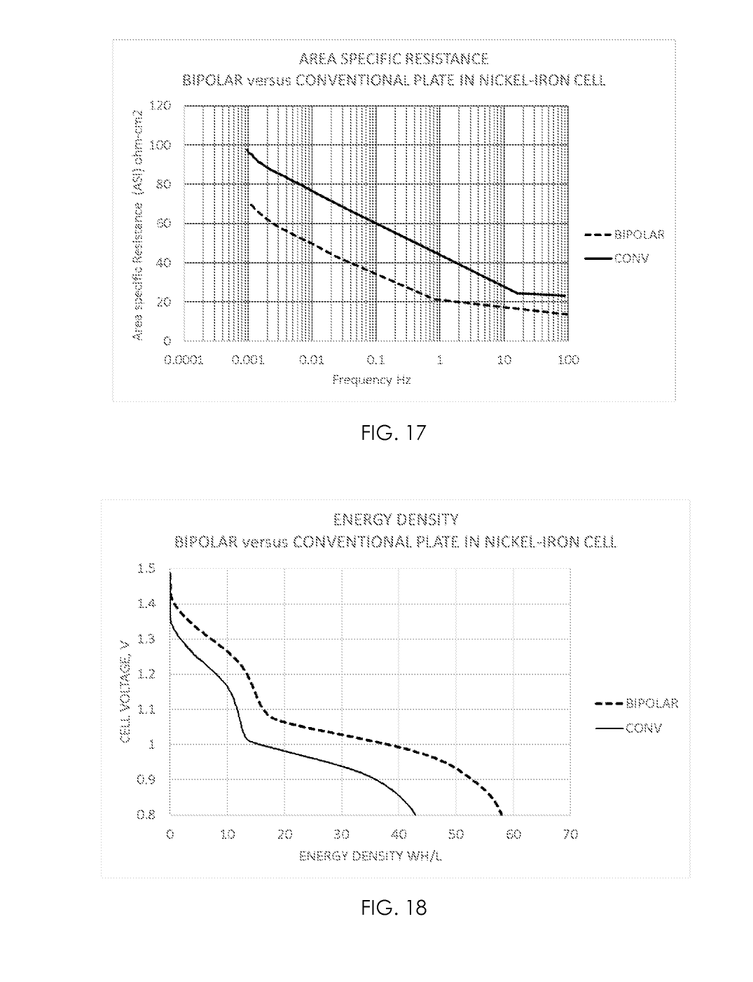

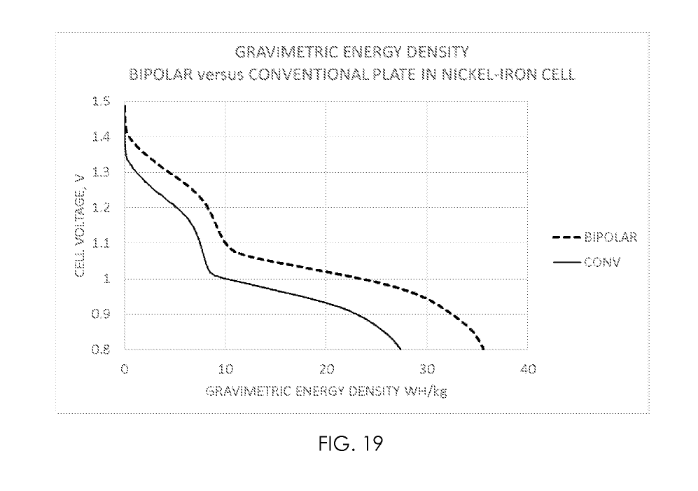

In operation, and referring to FIGS. 17-19, embodiments of the present technology demonstrate improved performance compared to conventional nickel-iron batteries. Specifically, embodiments of the present technology demonstrate lower area specific resistance at frequencies ranging from 0.001 Hz to 100 Hz, higher energy density across voltages ranging from 0.8 V to 1.5 V, and higher gravimetric energy density across voltages ranging from 0.8 V to 1.5 V.

Various embodiments of present technology may exhibit various improvements over a conventional mono-polar nickel-iron battery. Such improvements may include: higher discharge voltage since the internal resistance is lower; lower weight since only two current collectors are employed per half-plate (versus four for a conventional design); lower cost since the permeable layer replaces a nickel-plated steel plate; lower manufacturing cost since there no need for electrical welding; higher energy density due to having higher efficiency, higher voltage, and lower weight.

In the foregoing description, the technology has been described with reference to specific exemplary embodiments. The particular implementations shown and described are illustrative of the technology and its best mode and are not intended to otherwise limit the scope of the present technology in any way. Indeed, for the sake of brevity, conventional manufacturing, connection, preparation, and other functional aspects of the method and system may not be described in detail. Furthermore, the connecting lines shown in the various figures are intended to represent exemplary functional relationships and/or steps between the various elements. Many alternative or additional functional relationships or physical connections may be present in a practical system.

The technology has been described with reference to specific exemplary embodiments. Various modifications and changes, however, may be made without departing from the scope of the present technology. The description and figures are to be regarded in an illustrative manner, rather than a restrictive one and all such modifications are intended to be included within the scope of the present technology. Accordingly, the scope of the technology should be determined by the generic embodiments described and their legal equivalents rather than by merely the specific examples described above. For example, the steps recited in any method or process embodiment may be executed in any order, unless otherwise expressly specified, and are not limited to the explicit order presented in the specific examples. Additionally, the components and/or elements recited in any apparatus embodiment may be assembled or otherwise operationally configured in a variety of permutations to produce substantially the same result as the present technology and are accordingly not limited to the specific configuration recited in the specific examples.

Benefits, other advantages and solutions to problems have been described above with regard to particular embodiments. Any benefit, advantage, solution to problems or any element that may cause any particular benefit, advantage or solution to occur or to become more pronounced, however, is not to be construed as a critical, required or essential feature or component.

The terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present technology, in addition to those not specifically recited, may be varied or otherwise particularly adapted to specific environments, manufacturing specifications, design parameters or other operating requirements without departing from the general principles of the same.

The present technology has been described above with reference to an exemplary embodiment. However, changes and modifications may be made to the exemplary embodiment without departing from the scope of the present technology. These and other changes or modifications are intended to be included within the scope of the present technology, as expressed in the following claims.

1. A bipolar plate, comprising:
a first half-plate, comprising:
a first plate comprising a first major surface and an opposing second major surface;
a first plurality of protuberances disposed on the second major surface of the first plate;
a first non-electrically conductive permeable layer arranged parallel to the first plate; and
a first plurality of pellets of a first polarity positioned between the second major surface of the first plate and the first non-electrically conductive permeable layer;
a second half-plate arranged parallel to the first half-plate and comprising:
a second plate comprising a first major surface and an opposing second major surface;
a second plurality of protuberances disposed on the second major surface of the second plate;
a second non-electrically conductive permeable layer arranged parallel to the second plate; and
a second plurality of pellets of a second polarity positioned between the second major surface of the second plate and the second non-electrically conductive permeable layer; and
a separating layer positioned between the first half-plate and the second half-plate.

2. The bipolar plate of claim 1, further comprising a side rail along an edge of at least one of the first half-plate and the second half-plate.

3. The bipolar plate of claim 1, further comprising:
a first tab coupled to and extending outwardly from the first half-plate; and
a second tab coupled to and extending outwardly from the second half-plate.

4. The bipolar plate of claim 1, wherein each protuberance of the plurality of first and second protuberances comprises at least one opening having a height in the range of 20 to 200 microns and a width in the range of 0.10 to 4.00 millimeters.

5. The bipolar plate of claim 1, further comprising a first gasket at a first end and a second gasket at an opposing second end of at least one of the first half-plate and the second half-plate.

6. The bipolar plate of claim 1, wherein each of the first and second non-electrically conductive permeable layers comprises a hydrophilic polymer.

7. The bipolar plate of claim 1, wherein each of the first and second non-electrically conductive permeable layers comprises a perforated film of hydrophilic and hydrophobic polymers.

8. The bipolar plate of claim 1, wherein:
the first plate further comprises an edge that extends up and around an edge of the first non-electrically conductive permeable layer; and
the second plate further comprises an edge that extends up and around an edge of the second non-electrically conductive permeable layer.

9. A mono-polar battery, comprising:
a plurality of layered stacks, each layered stack comprising, and in the order of:
a first current collector comprising a first plurality of protuberances;
a first plurality of charged pellets having a first polarity;
a first non-electrically conductive permeable layer;
a first separator;
a second non-electrically conductive permeable layer;
a second plurality of charged pellets having a second polarity; and
a second current collector comprising a second plurality of protuberances; and
a plurality of second separators, wherein one second separator of the plurality of second separators is disposed between adjacent layered stacks.

10. The mono-polar battery of claim 9, further comprising:
a first tab disposed between a portion of the first current collector and the first non-electrically conductive permeable layer and extending outside the layered stack; and
a second tab disposed between a portion of the second current collector and the second non-electrically conductive permeable layer and extending outside the layered stack.

11. The mono-polar battery of claim 9, further comprising a side rail configured to secure the first current collector, the first plurality of charged pellets, and the first non-electrically conductive permeable layer together.

12. The mono-polar battery of claim 9, wherein each protuberance of the first and second plurality of protuberances comprises at least one opening having a height in the range of 20 to 200 microns and a width in the range of 0.10 to 4.00 millimeters.

13. The mono-polar battery of claim 9, wherein the first and second non-electrically conductive permeable layers comprise one of: a hydrophilic polymer and a perforated film of hydrophilic and hydrophobic polymers.

14. The mono-polar battery of claim 9, wherein:
the first current collector further comprises an edge that extends up and around an edge of the first non-electrically conductive permeable layer; and
the second current collector further comprises an edge that extends up and around an edge of the second non-electrically conductive permeable layer.

15. A mono-polar battery, comprising:
a plurality of stacked bipolar plates, each bipolar plate comprising:
a negatively-charged half-plate comprising:
a first current collector comprising:
a first major surface and an opposing second major surface; and
a first plurality of protuberances;
a first non-electrically conductive permeable layer in parallel with the first current collector; and
a plurality of negatively-charged pellets positioned between the first current collector and the first non-electrically conductive permeable layer;
a positively-charged half-plate positioned in parallel with the negatively-charged half-plate, and comprising:
a second current collector comprising:
a first major surface and an opposing second major surface; and
a second plurality of protuberances;
a second non-electrically conductive permeable layer in parallel with the second current collector; and
a plurality of positively-charged pellets positioned between the second current collector and the second non-electrically conductive permeable layer; and
a first separator positioned between and adjacent to the first and second non-electrically conductive permeable layers; and
a plurality of second separators, wherein one second separator of the plurality of second separators is disposed between adjacent bipolar plates.

16. The mono-polar battery of claim 15, further comprising:
a first tab coupled to and extending outwardly from the negatively-charged half-plate; and
a second tab coupled to and extending outwardly from the positively-charged half-plate.

17. The mono-polar battery of claim 15, further comprising a side rail along an edge of at least one of the negatively-charged half-plate and the positively-charged half-plate.

18. The mono-polar battery of claim 15, wherein each protuberance of the first and second plurality of protuberances comprises at least one opening having a height in the range of 20 to 200 microns and a width in the range of 0.10 to 4.00 millimeters.

19. The mono-polar battery of claim 15, further comprising a first gasket at a first end and a second gasket at an opposing second end of at least one of the negative half-plate and the positive half-plate.

20. The mono-polar battery of claim 15, wherein:
the first current collector further comprises an edge that extends up and around an edge of the first non-electrically conductive permeable layer; and
the second current collector further comprises an edge that extends up and around an edge of the second non-electrically conductive permeable layer.
